(19) United States
(12) Patent Application Publication
(10) Pub. No.: US 2022/0108041 A1
(43) Pub. Date: Apr. 7, 2022

(54) EXTERNAL SECURE AND ENCRYPTED SSD DEVICE AND A SECURE OPERATING SYSTEM ON AN EXTERNAL SSD DEVICE

(71) Applicant: HS SENCDRIVE INC., Vancouver (CA)

(72) Inventor: Sergei Semeikin, Gusevo village (RU)

(73) Assignee: HS SENCDRIVE INC., Vancouver (CA)

(21) Appl. No.: 16/948,996

(22) Filed: Oct. 8, 2020

(30) Foreign Application Priority Data
Oct. 7, 2020 (CA) 3095632

(51) Int. Cl. G06F 21/79; G06F 21/60; G06F 21/83; G06F 21/86; G06F 13/40; H01L 23/31; H01L 23/29

(52) U.S. Cl. CPC G06F 21/79; G06F 21/602; G06F 21/83; G06F 21/86; G06F 2213/0032; H01L 23/3164; H01L 23/293; G06F 2221/2143; G06F 13/4068

(57) ABSTRACT

This invention relates to an external secure and encrypted SSD device that achieves the high write and read speed and storage volume of larger devices. This invention also relates to an external SSD device with an operating system wherein the operating system is booted up through the firmware of the external SSD device rather than through the operating system of an external computer.

### FIELD OF INVENTION

This invention relates to external memory drive devices for storage of computer data, and more particularly to an external secure and encrypted SSD device and a secure operating system that works on an external SSD device.

### BACKGROUND OF THE INVENTION

External memory drive devices such as USB flash drives, portable drives, and memory card readers are well known. These devices may be small and easy to transport.

Smaller size is a feature of external data drives that aids in portability and storage. U.S. Pat. No. 9,167,696 describes a low profile memory module in which an electronic component module includes a printed circuit board with a low-profile plug, wherein a connector for connecting the printed circuit board to a motherboard (and mateable with the plug) has a z-height of no more than about 1.5 mm.

However, the advantage of small size may also be a disadvantage since such small external drives can easily be lost or stolen and may not have sufficient storage capacity. U.S. Pat. No. 9,033,143 describes a credit-card-sized carrier of flash-memory cards. Multiple memory cards fit into bays in the side of the carrier with spring clips to retain them, which secures the flash-memory cards to prevent loss. The carrier can fit into a wallet. However, if all or any of the memory cards are stolen, the data will be available to anyone to access.

If an external memory drive device does not protect the data on it, anyone who finds or steals the external memory drive also has access to the computer data stored on it. As such, there are also external memory drive devices with security features to protect against third party access to the data. U.S. Pat. No. 8,010,768 describes a secure and scalable solid state disk system which may be used with portable storage devices. In addition to method claims there is a computer readable medium containing program instructions for re-synchronizing a secure and scalable solid state disk system (SSDS) with a host.

U.S. Pat. No. 10,776,301 discloses an encrypted solid state drive (SSD) comprising memory units that are each capable of hosting different operating systems from each other simultaneously. Whereas many traditional SSDs only provide storage functions for data reading and writing, U.S. Publication No. 2020/0241970 discloses a solid state drive that can backup data and also recover the deleted data. The SSD includes a first storage area, which is visible to the operating system in the solid-state drive; a second storage area, which is set to be invisible to the operating system. U.S. Pat. No. 10,521,571 discloses a secure storage device that utilizes encryption keys and physical key input devices to protect the data stored in the device. A user must enter a personal identification number (PIN) via a physical keypad to unlock the device. A self-destruct PIN may be entered to erase the contents of the device.

In the marketplace, Secure Data Inc. of the U.S. has an external encrypted SSD called SecureDrive™ KP which is about 125×77×20.5 mm and 225 grams; iStorage Limited of the U.K. has an external encrypted SSD called iStorage™ with diskAshur²™ level certification of PIN authentication which has the approximate dimensions of 124×84×19 mm and weighs about 180 grams; and Kingston Technology Company of the U.S. has an external encrypted flash drive called DataTraveler® 2000 which has the approximate dimensions of 83×40×10 mm and weighs about 38 grams. All these devices use the same data encryption algorithm (AES-256, which is the de facto standard in the encryption world), and a PIN code is used to unlock the data. The SecureDrive™ KP and iStorage™ use classic SSD format drives. The DataTraveler®2000 uses the classic old format of flash memory and therefore loses in write and read speed (250/200 MB/s) and has only a storage volume of 128 Gb, although it is much smaller in size than the iStorage™ and DataTraveler®2000.

The current encrypted SSD devices have software encryption wherein a chip on the printed circuit board to encrypt the data stored therein, and the data is unlocked by software installed on the computer (or other device) in which the SSD device is inserted. The chip on the printed circuit board is responsible for encrypting data, but the SSD device uses software installed on the computer to unlock the data.

Currently there are three types of encryption standard for SSD devices:

1. Software encryption (as described in the above paragraph). To encrypt and decrypt information on a given device, the power of a computer's CPU and RAM is used through a special encryption software program. Since the encryption function uses computer resources, and also stores private and public encryption keys on the system disk, there are a large number of weaknesses in the protection and reliability of this system.
2. Hardware encryption. For encryption and decryption of data, in which only a chip or a set of chips integrated on a printed circuit board of the device is used. A built-in keyboard, fingerprint scanner, and RFID tag can be used for unlocking it. This is a high-level form of security for protecting data.
3. Software & hardware encryption. Similar to hardware encryption, but the device does not have a keyboard or scanner, rather, software installed on a computer is used to unlock the data. In such a program, a password is set to access the device. The disadvantages of this technology are the ability to determine a password by brute-force by installing various viruses and password crackers.

It is desirable to have a smaller external secure and encrypted SSD device that achieves a high write and read speed as well as the storage volume of larger devices, and it is desirable to protect against hacking when the data on an SSD device is being accessed with an external computer.

### SUMMARY OF INVENTION

In an embodiment of the present invention, there is a solid state drive device with an operating system, comprising an outer casing, and within said casing comprising a printed circuit board, a solid state drive, at least one memory chip, and at least one bridge chip programmed with firmware, and wherein the operating system is programmed to run through the firmware.

In a further embodiment of the present invention, there is a solid state drive device with an operating system, wherein the operating system is programmed to clear any random access memory created when used on an external computing device after the external computing device is restarted.

In a further embodiment of the present invention, there is a solid state drive device with an operating system wherein the solid state drive is an M.2 2242 SATA.

The solid state drive device with an operating system may comprise encryption software.

The solid state drive device with an operating system may comprise encryption and password protection and an outer casing with keys for entering a password, and any data stored on the at least one memory chip can not be accessed without entering a correct password on the keys.

In a further embodiment of the present invention, there is a solid state drive device with an operating system which is programmed to delete the data from the memory chip and disable the solid state drive if an incorrect password is entered a pre-set number of times.

In a further embodiment of the present invention, there is an external secure and encrypted SSD drive comprising an outer casing, and within said casing comprising a printed circuit board, at least one memory chip, at least one bridge chip programmed with firmware, and a solid state drive comprising an M.2 2242 SATA.

The external secure and encrypted SSD drive may have a printed circuit board covered in an epoxy resin and at least one side of the printed circuit board is covered with a copper foil shield.

The external secure and encrypted SSD drive may additionally comprise tamper proof keys, and be programmed to delete the data from the memory chip and disable the solid state drive if an incorrect password is entered a pre-set number of times.

### DESCRIPTION OF DRAWINGS

These and other aspects of the present invention will be apparent from the brief description of the drawings and the following detailed description in which:

FIG. 1a is a perspective view of an external secure and encrypted SSD device according to an embodiment of the present invention.

FIG. 1b is a front view of the external secure and encrypted SSD device of FIG. 1a.

FIG. 1c is a right-side view of the external secure and encrypted SSD device of FIG. 1a.

FIG. 1d is a top view of the external secure and encrypted SSD device of FIG. 1a.

FIG. 1e is a bottom view of the external secure and encrypted SSD device of FIG. 1a.

FIG. 2a is a perspective exploded view of a casing with keys of an external secure and encrypted SSD device according to an embodiment of the present invention.

FIG. 2b is an exploded view of the external secure and encrypted SSD device of FIG. 1a.

FIG. 3a is a front perspective view of a schematic depiction of a printed circuit board (“PCB”) with an SSD of an external secure and encrypted SSD device according to an embodiment of the present invention.

FIG. 3b is a front view of the PCB with SSD of FIG. 3a.

FIG. 3c is a right-side view of the PCB with SSD of FIG. 3a.

FIG. 3d is a back-perspective view of the PCB with SSD of FIG. 3a.

FIG. 3e is a back view of the PCB with SSD of FIG. 3a.

FIG. 4 is a PCB layout of a first layer of the PCB of FIG. 3a.

FIG. 5 is a PCB layout of a second layer of the PCB of FIG. 3a.

FIG. 6 is a PCB layout of a third layer of the PCB of FIG. 3a.

FIG. 7 is a schematic illustration of the functionality and connectivity of f an external secure and encrypted SSD device according to an embodiment of the invention.

FIG. 8 is a screenshot opened to “Favorites” of a design of an operating system on an encrypted SSD device of an embodiment of the present invention.

FIG. 9 is a screenshot opened to “Applications” of a design of an operating system on an encrypted SSD device of an embodiment of the present invention.

FIG. 10 is a screenshot opened to “Settings” of a design of an operating system on an encrypted SSD device of an embodiment of the present invention.

### DETAILED DESCRIPTION OF INVENTION

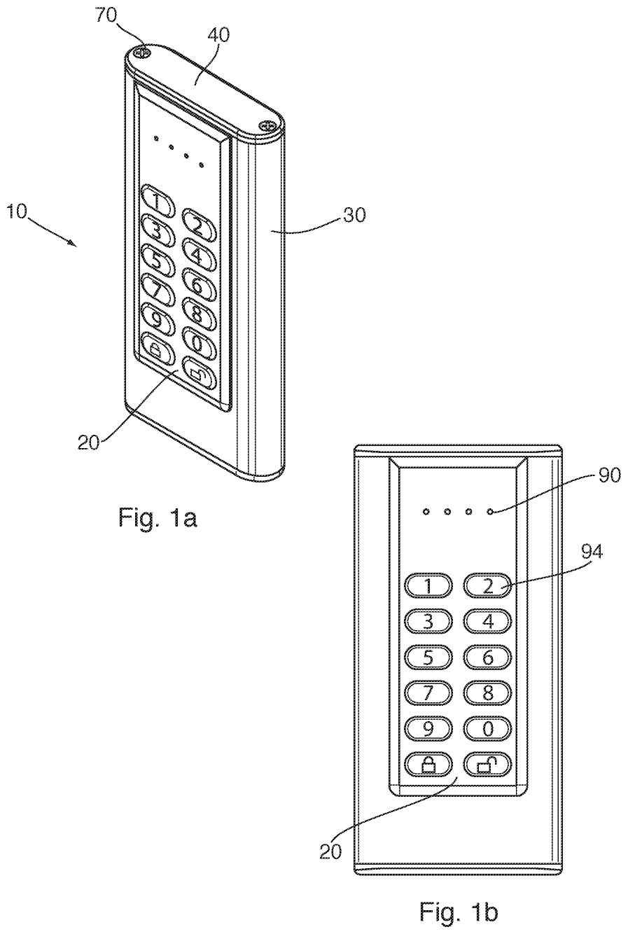

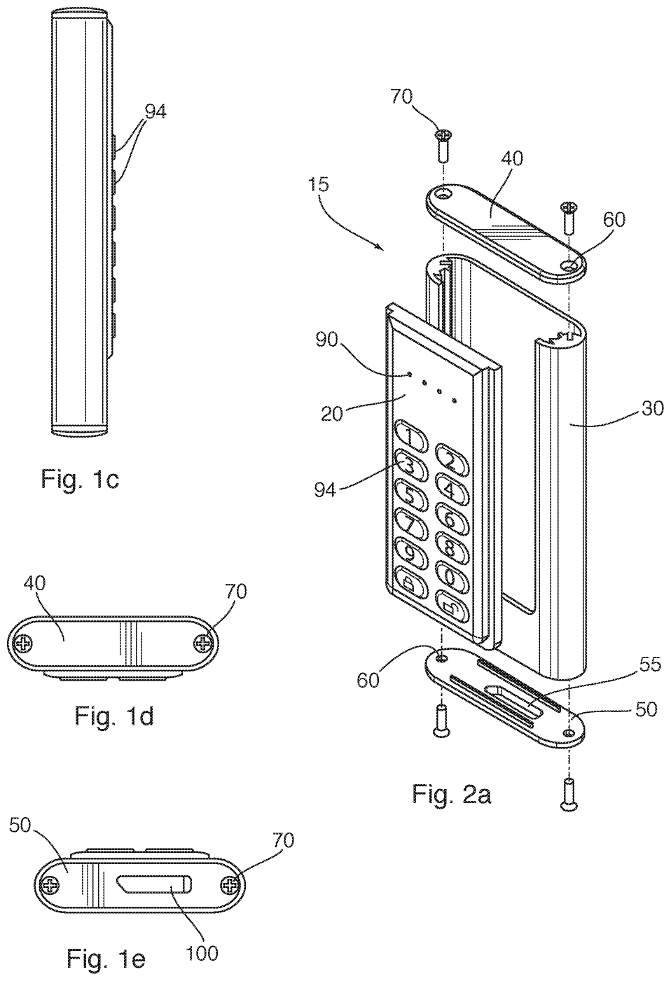

In an embodiment of the invention as shown in FIGS. 1a to 1e, there is an external secure and encrypted SSD device 10 with a USB port 100. Data stored on the external secure and encrypted SSD device 10 is protected by encryption (software based) and security features (hardware based).

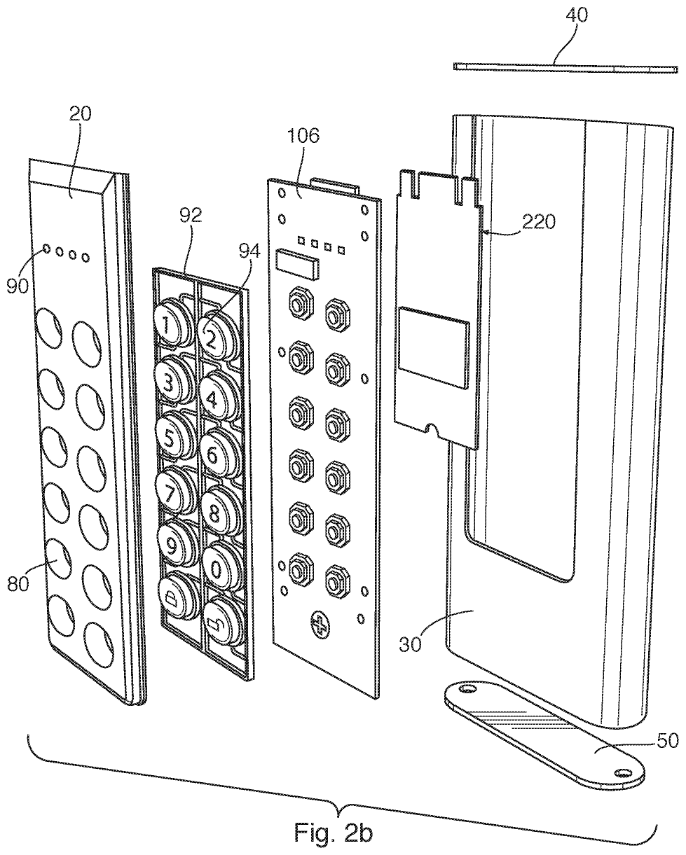

As shown in FIGS. 2a and 2b, the casing 15 of the external secure and encrypted SSD device 10 has a casing front 20, casing back 30, casing top 40 and casing bottom 50 with USB port opening 55. Both the casing top 40 and casing bottom 50 have screw holes 60 and screws 70. On the casing front 20 there are key holes 80 and LED light holes 90. The casing additionally has keys 94 inserted in the casing front through the holes 80.

FIG. 2b is an exploded view of the external secure and encrypted SSD device 10 showing a schematic depiction of the internal components. The external secure and encrypted SSD device 10 comprises the casing front 20, a key panel 92 with keys 94, a PCB 106, an SSD 220, the casing back 30, casing top 40 and casing bottom 50.

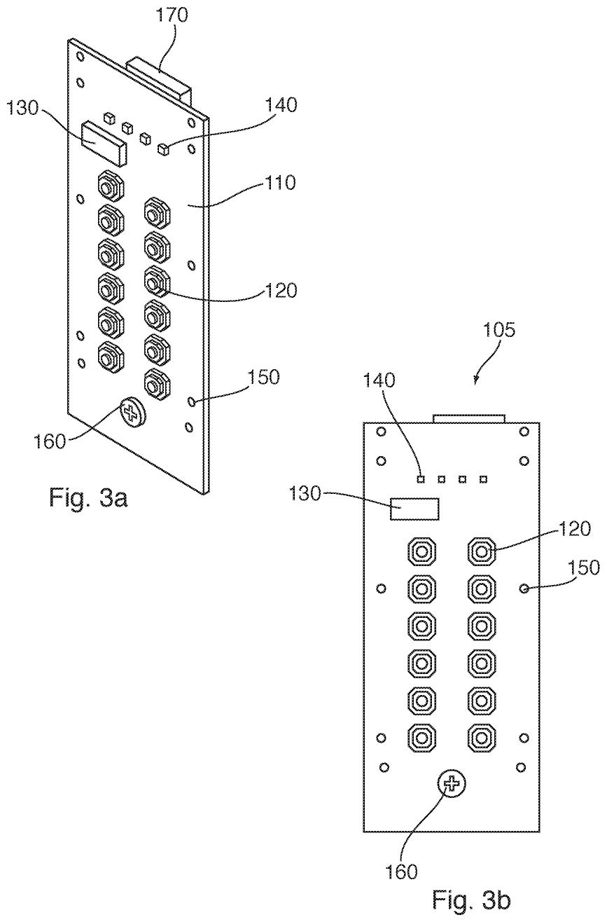

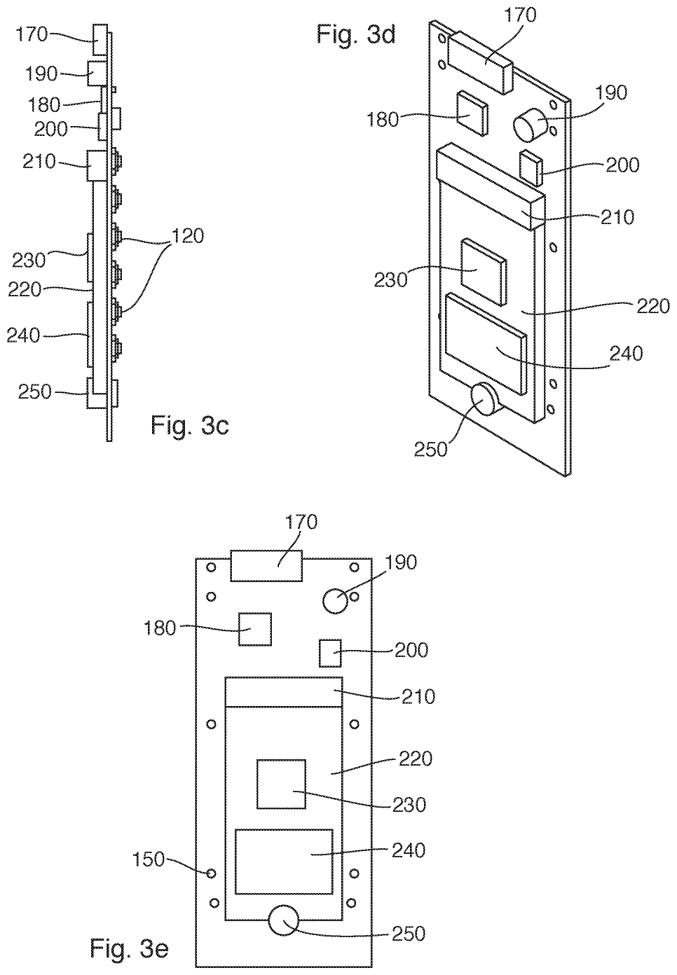

FIGS. 3a to 3e show a schematic depiction of the PCB with SSD 105 of an embodiment of the present invention. The front of the PCB with SSD 105 has buttons 120 (corresponding with the keys 94 of the key panel 92). The PCB with SSD 105 also features a memory chip 130 and LED lights 140 to indicate activities. Mounting holes 150 pass through the three layers of the PCB 106. The bolt 160 and nut 250 fix the SSD 220 to the back of the PCB 106.

The back of the PCB 106 has the SSD 220. In an embodiment of the invention the SSD 220 is an M.2 2242 SATA. Use of this M.2 2242 SATA SSD 220 reduces the size and weight of the external secure and encrypted SSD device 10.

On the back of the first PCB 105 there is also a USB 170, for example, a micro USB type B Gen 3.0 connector. A bridge chip 180 transfers information between buses and encrypting information, for example the bridge chip 180 may be an Initio™ INIC 3637, chip 180 may be FIPS 140-2 level 3 certified and NIST certified. The back of the first PCB 105 also has a PIC (“programmable intelligent computer”) controller 200 and a connector 210, for example, NGFF M.2, for connecting the SSD 220. There is a bridge controller 230 on the SSD 220, and a memory storage chip 240. The memory storage chip 240 may vary to offer storage volumes of 128 Gb, 256 Gb, 512 Gb, 1 Tb, 2 Tb, or another amount. For example, the memory storage chip 240 may be Micron's 3D TLC NAND RAM modules.

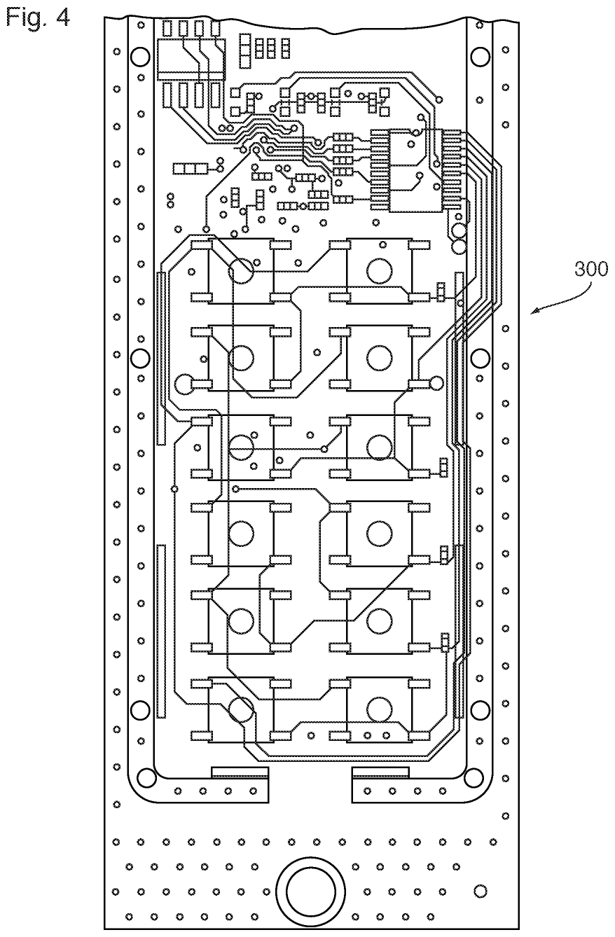

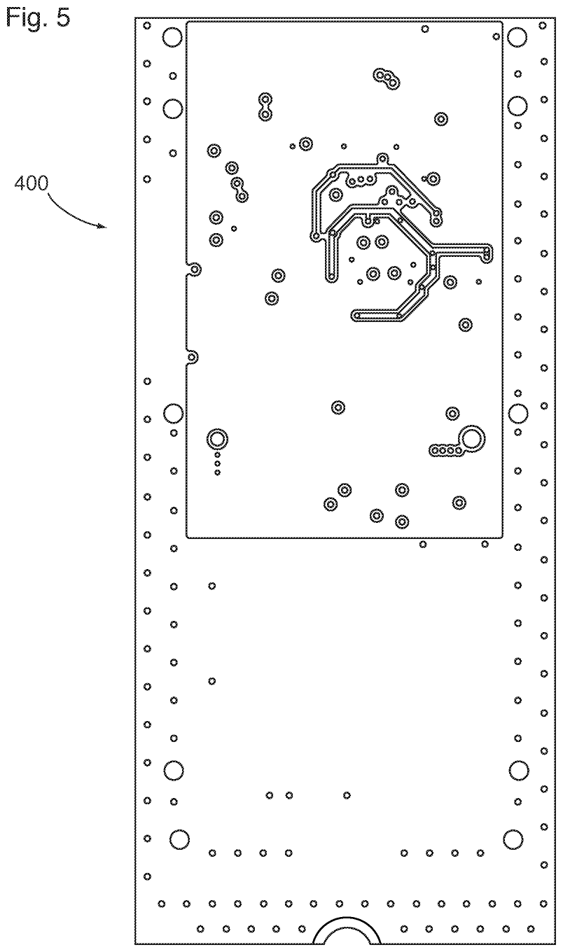

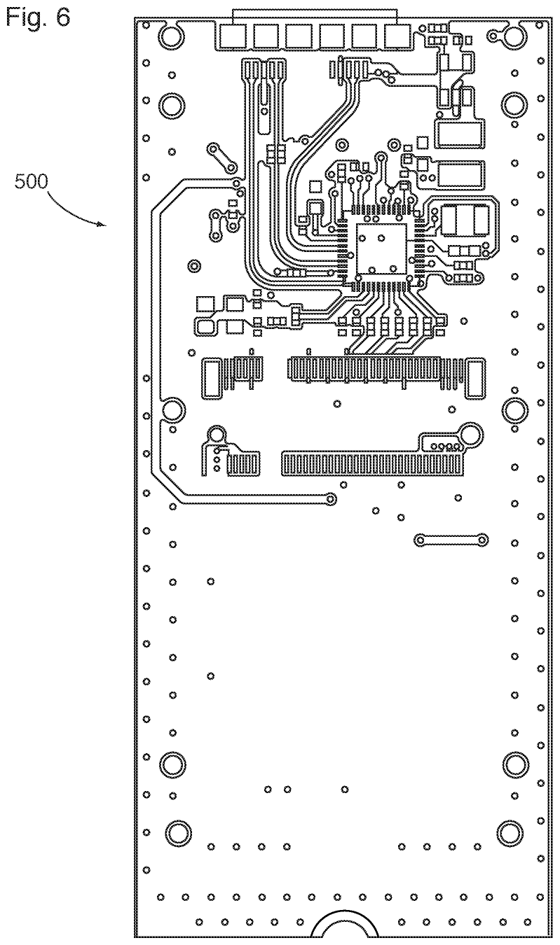

FIG. 4 is an embodiment of a PCB layout of a first layer 300 of the PCB 106. FIG. 5 is an embodiment of a PCB layout of a second layer 400 of the PCB 106 of the external secure and encrypted SSD device 10. FIG. 6 is an embodiment of a PCB layout of a third layer 500 of the PCB 106 of the external secure and encrypted SSD device 10.

In the external secure and encrypted SSD device 10 of the present invention the PCB with SSD 105 is covered in a high temperature epoxy resin (not shown) and then the front and back are each protected by a copper foil shield (not shown). The epoxy prevents tampering since memory chip components would be destroyed in trying to remove the epoxy, known as brute force hacking. The copper foil shield protects against data interception using electromagnetic radiation (e.g. TEMPEST attacks).

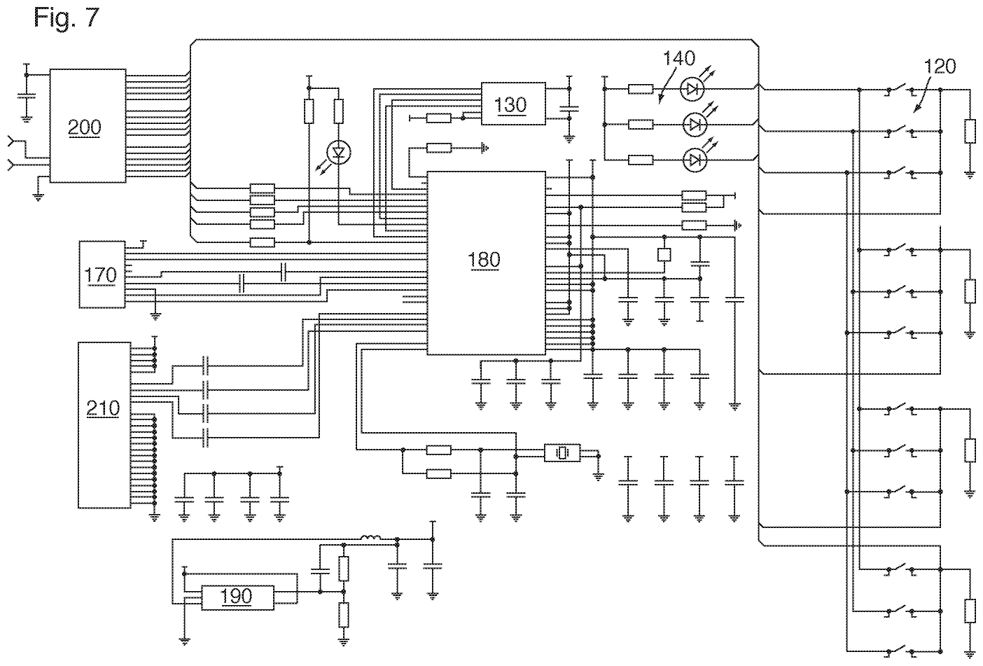

FIG. 7 is a schematic illustration of the functionality and connectivity of the external secure and encrypted SSD device 10 according to an embodiment of the invention.

In an embodiment of the present invention in which the SSD 220 is an M.2 2242 SATA, the embodiment of the external secure and encrypted SSD device 10 of the present invention is put together by the key panel 92 being adhered onto the back of the casing front 20 with the keys 94 inserted into the key holes 80 of the casing front 20. The PCB with SSD 105 in epoxy resin covering and copper foil shield (not shown) are adhered onto the back of the key panel 92 and casing front 20, then the casing front 20 slides into the grooves in the casing back 30 for a snug fit (after which the casing top 40 and casing bottom 50 are attached).

External secure and encrypted SSD device 10 has the dimensions: 82.5 mm×40 mm×12 mm and the weight of 28 to 38 grams (depending on storage capacity/volume). For example, the storage capacity may be: 128 Gb/256 Gb/512 Gb/1 Tb/2 Tb. Devices of similar size have a maximum capacity of no more than 256 Gb since they do not use the M.2 2242 SATA for the SSD 220. Despite the smaller size, this external secure and encrypted SSD device has a write and read speed comparable to larger devices, namely: write 250 mb/s, read 210 mb/s.

The firmware that may be used is available from third parties, such as, Initio Inc. which is provided in executable file format. The firmware of such bridge chips remains in the ownership of the manufacturer. Software programs allow for writing the firmware to the chip.

It is not possible to change or rewrite the firmware on the bridge chip for two reasons:

1. To order a new firmware, the firmware manufacturer would need to be contacted directly with the terms of reference and a detailed description of the PCB and the chip used; and
2. To download the firmware to the external secure and encrypted SSD device 10, the secret PIN on the PIC controller 200 must be known and this is only known by the manufacturer of the external secure and encrypted SSD device 10.

In the present invention, a hacker is mechanically blocked from loading new firmware onto the bridge chip 180. The bridge chip 180 can only be unlocked by the secret PIN for each PIC controller 200 which mechanically connects the contacts on the PIC controller 200. Again, this secret PIN for each PIC controller 200 is only known by the manufacturer of the external secure and encrypted SSD device 10.

The external secure and encrypted SSD device 10 requires no software drivers or updates and works on all computer and embedded systems that support standard USB protocol. The external secure and encrypted SSD device 10 must be connected to a computer for use. When disconnecting the USB cable connecting the external secure and encrypted SSD device 10 to the computer my be unplugged. For some computers, there is a further step, for example, an eject icon, within the operating system prior to unplugging the USB cable. To lock the external secure and encrypted SSD device 10 without unplugging the USB cable, the lock button of the keys 94 may be pressed and held until the set LED light 90 lights.

For encryption, the industry standard data encryption algorithm, AES-256 XTS, is used, but it will be understood that alternative and future data encryption algorithms may be used. The secure and encrypted SSD device 10 has AES-256 hardware encryption built on the bridge chip. This encryption configuration creates two security keys, one private key and one public key. The private key is stored in the bridge chip in internal memory, the public key is stored in the SSD 220. In order for the bridge chip to unlock the data on the SSD 220, a person must enter his password on the PIN-keyboard, and if it is correct, the bridge chip 180 decrypts the data on the SSD 220 and carries out the drive initialization procedure in the operating system. This is a very secure encryption method.

The external secure and encrypted SSD device 10 can't be accessed without entering a PIN (personal identification number). The PIN code on the secure and encrypted SSD device 10 reveals the presence of hardware encryption. To unlock the data on the bridge chip 180, the chip 180 must receive information about the correct authentication of the owner. In an embodiment of the present invention, this information is a PIN code from 3 to 16 digits long. The PIC controller 200 transmits data to the bridge chip 180, which decrypts the information on the SSD 220 and makes it available.

For hardware security the casing is temper proof, there is a PIN code, and there is protection from brute force PIN code selection. The external secure and encrypted SSD device 10 may be made of brushed aluminum or stainless steel and plastic for the casing front 20 and keys 94. Using wear resistant keys 94 avoids tipping off potential hackers to commonly used keys. In operation, a PIN code of 4-16 characters may be used to unlock the data on the external secure and encrypted SSD device 10, and after a number of incorrect attempts to enter the PIN code (e.g. ten tries), all data on the external secure and the external secure and encrypted SSD device 10 is destroyed.

The port 100 of the external secure and encrypted SSD device 10 works with a complementary cable, and various types of ports and connectors may be utilized. Cables for connecting the external secure and encrypted SSD device 10 to a laptop, desktop or phone may be used, and a cable may have various USB type connectors with at least one connector for the corresponding device port, for example, a USB 3.1 Type A connector on one end and a 10-pin USB 3.1 Gen Micro Type B connector.

In an embodiment of the external secure and encrypted SSD device 10, there are four LED lights and the colours are red, blue, green and yellow. For example, activities or status may be indicated as follows:
Yellow: password change indicator
Green: unlock and button pressing indicator
Red: lock and error indicator
Blue power and data access indicator

In a further example, combinations of colours indicate further activities:
Red and Blue solid colours: power and locked
Green blinking: keypad input or preparing to unlock
Green and Blue solid: unlocked, operation was successful
Red blinking, Blue solid: PIN error
Yellow, Red, Blue solid: Change PIN

In a further embodiment of the present invention the external secure and encrypted SSD device 10 also includes an operating system on the SSD device 10. The operating system is pre-installed on the external secure and encrypted SSD device 10 and is similar in operation to other operating systems such as Windows™ or macOS™ operating systems. However, in use the external secure and encrypted SSD device 10 is connected to a computer (or other such device) and the operating system is booted up through the BIOS (which is a set of computer instructions in the firmware which control input and output operations). This means that the data is still being used through the operating system on the SSD device 10 rather than an operating system on the external computer, which provides security even then using on public computers.

In an embodiment of the invention the operating system automatically clears the RAM (“random access memory”) on the computer with a special command when the computer is turned off and restarted—this is the only indication of the Tails memory erasure from the work of the operating system on the SSD 220.

The operating system is pre-installed on the secure and encrypted SSD device 10. To enter the system, the user needs to connect the device 10 to a computer and boot from it through the BIOS, thereby the user can use any even public computers and work safely without worrying about data leaks.

The technical characteristics of the operating system on the secure and encrypted SSD device 10 are:
based on Linux™ 64 bit kernel
the occupied space on the disk is not more than 1.3 Gb
UEFI or Secure Boot support
Pre-installed applications for office work, multimedia, work with graphics, access to the application database (more than 5000 applications may be loaded).

The standard applications that may be included are an office software suite, a browser, an email client, multimedia applications, cryptocurrency wallets, and others may be added.

The hardware required to use the external secure and encrypted SSD device 10 with an operating system are the ability to start from a USB (UEFI); ability to install virtualization software, such as Oracle VM VirtualBox™; a compatible processor; and enough RAM, such as 2 or more GB.

There is a set of security and anonymity technical solutions that contribute to the hacker resistance of the operating system as follows:

the software for encrypting all user information is on the secure and encrypted SSD device 10, in combination with hardware data encryption through the chip;

a secure VPN service through the servers of the manufacturer of the secure and encrypted SSD device 10 which makes access to the network secure and anonymous (using an end-to-end gateway with data encryption according to the TSL 1.2 standard); and

a firewall that protects against external attacks in the form of viruses, phishing and personal information leakage.

This operating system allows the user of the SSD device 10 to remain anonymous and keep their data safe.

In a further embodiment of the present invention there is a non-secure and non-encrypted SSD device with an operating system which boots up through the BIOS. However, if the SSD device 10 is unencrypted, the data on it will be vulnerable to attackers

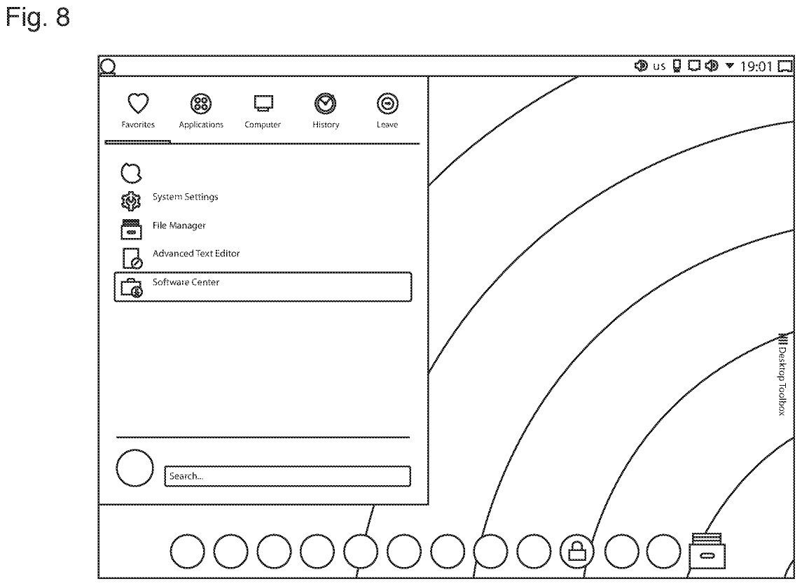

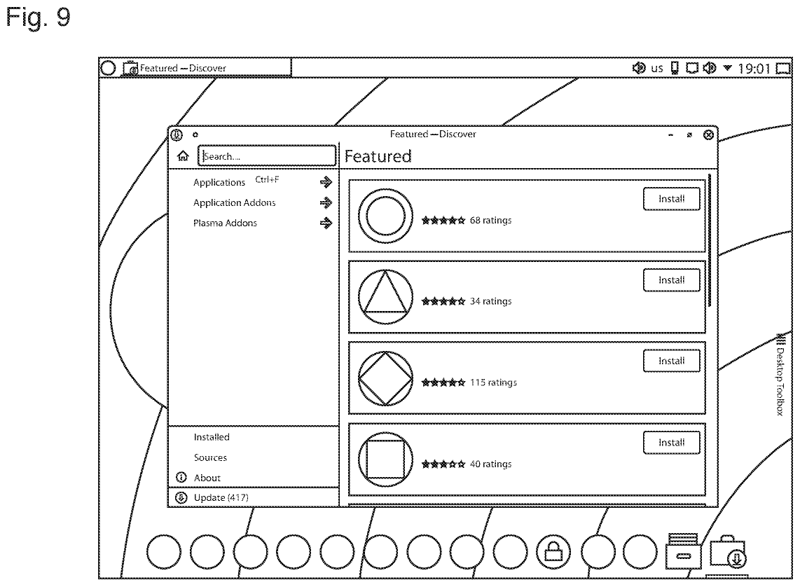

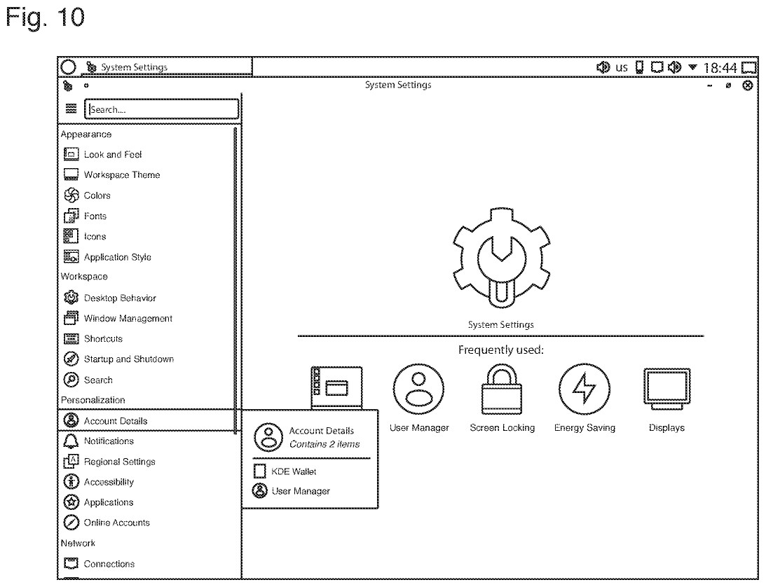

The operating system on the external secure and encrypted SSD device 10 may have a user-friendly graphical interface and a set of utilities for comprehensive security. An embodiment of a graphical interface of the operating system of the present invention is shown in FIGS. 8 to 10. FIG. 8 is a screenshot opened to “Favorites” of a design of an operating system on an encrypted SSD device 10 of an embodiment of the present invention. FIG. 9 is a screenshot opened to “Applications” of a design of an operating system on an encrypted SSD device of an embodiment of the present invention. FIG. 10 is a screenshot opened to “Settings” of a design of an operating system on an encrypted SSD device 10 of an embodiment of the present invention.

In operation of an embodiment of the external secure and encrypted SSD device 10 with operating system, a new user of the external secure and encrypted SSD device 10 attached a USB cable (not shown) by connecting one end into the port 100 of the external secure and encrypted SSD device 10 and the other end into an external computer (not shown). The user enters the manufacturer's PIN (e.g. 112233) on the keys 80 and presses the unlock button. The user should change the PIN to their own secret number from 4 to 16 digits. The user may then enter their own password on the keys 92 of the external secure and encrypted SSD device 10 which allows the user to see the graphical interface of the operating system on the external computer. The operating system on the external secure and encrypted SSD device 10 of the present invention is booted up. The system automatically finds an active connection and connects to it, and the manufacturer's VPN network is selected to access the internet. The connections are routed through an encrypted SSL channel.

The user may transfer files from the external computer onto the external secure and encrypted SSD device 10 and may work on these files using the operating system of the present invention. If the user already has files on the external secure and encrypted SSD device 10 the user may likewise work on them using the operating system of the present invention. To safely log out, the system should be shut down which terminates all processes and encrypts all data on the external secure and encrypted SSD device 10, as well as shutting down the virtualization software or computer. When the user removes the external secure and encrypted SSD device 10 the user should reboot the computer since the external secure and encrypted SSD device 10 is programmed to clear the RAM. As such any of the files on the external secure and encrypted SSD device 10 (whether or not looked at while the user was on that external computer) will not be left on the external computer.

From the above detailed description, the operation and construction of the invention should be apparent. While there are herein shown and described example embodiments of the invention, it is nevertheless understood that various changes may be made with respect thereto without departing from the principle and scope of the invention.

We claim:

1. A solid state drive device with an operating system, comprising an outer casing, and within said casing comprising a printed circuit board, a solid state drive, at least one memory chip, and at least one bridge chip programmed with firmware, and wherein the operating system is programmed to run through the firmware.

2. The solid state drive device with an operating system of claim 1, wherein the operating system is further programmed to clear any random access memory created when used on an external computing device after the external computing device is restarted.

3. The solid state drive device with an operating system of claim 1, wherein the solid state drive is an M.2 2242 SATA.

4. The solid state drive device with an operating system of claim 1, which additionally comprises encryption software.

5. The solid state drive device with an operating system of claim 1, which additionally features encryption and password protection and which outer casing additionally comprises keys for entering a password, and wherein any data stored on the at least one memory chip can not be accessed without entering a correct password on the keys.

6. The solid state drive device with an operating system of claim 1, which is additionally programmed to delete the data from the memory chip and disable the solid state drive if an incorrect password is entered a pre-set number of times.

7. An external secure and encrypted SSD drive comprising an outer casing, and within said casing comprising a printed circuit board, at least one memory chip, at least one bridge chip programmed with firmware, and a solid state drive comprising an M.2 2242 SATA.

8. The external secure and encrypted SSD drive of claim 7, wherein the printed circuit board is covered in an epoxy resin and at least one side of the printed circuit board is covered with a copper foil shield.

9. The external secure and encrypted SSD drive of claim 8, additionally comprising tamper proof keys, and which is additionally programmed to delete the data from the memory chip and disable the solid state drive if an incorrect password is entered a pre-set number of times.
